(19) United States
(12) Patent Application Publication
(10) Pub. No.: US 2006/0179160 A1
(43) Pub. Date: Aug. 10, 2006

(54) Orchestral rendering of data content based on synchronization of multiple communications devices

(75) Inventors: Glen S. Uehara, Chandler, AZ (US); Joseph Patino, Pembroke Pines, FL (US); Fred R. Villa, Gilbert, AZ (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/053,477

(22) Filed: Feb. 8, 2005

(51) Int. Cl. G06F 15/16

(52) U.S. Cl. 709/248; 709/228

(57) ABSTRACT

An apparatus (102a) for causing an orchestrated rendering of pre-selected data content using a plurality of communications devices (102b-e) is provided. The apparatus includes a signal transmitting circuit (202) for transmitting a performance signal to at least one of the plurality of communications devices, the performance signal including a synchronization instruction. The apparatus additionally includes a synchronization module (208) communicatively connected to the transmitting circuit for generating the synchronization instruction. The synchronization instruction is based upon the pre-selected data content and causes the at least one communications device to perform a designated portion of the data content at a designated time during a rendering of the pre-selected data content.

### BACKGROUND

1. Field of the Invention

The present invention is related to the field of electronic communications, and, more particularly, to the coordinated rendering of data content using multiple electronic communication devices.

2. Description of the Related Art

Electronic communications devices are a ubiquitous feature of modern life, and the varied functions that they perform continue to expand. The expansion has been accelerated by the merging of computer-based technologies with telephony-based devices and systems. A result is that even the functions of the now-familiar mobile phone, one of the relatively newer additions to the array of standard electronic communications devices, have expanded beyond wirelessly conveying voice signals and now include the conveyance and processing of data content formerly limited to the domain of computers. It is expected that as this merging continues and wireless technology advances, ever-newer applications will emerge such as personalized weather forecasts, individualized real-time medical monitoring, and, perhaps, even the advent of electronic currency, all performed via a mobile phone.

Notwithstanding these advances, scant attention appears to have been paid to coordinating multiple communications devices, such as separate mobile or cellular phones, so as to achieve an advantageous or desirable rendering of sounds. For example, there appears to be no effective or efficient device or technique by which music can be performed orchestrally through an arrangement of multiple communications devices such as an array of spaced-apart cellular phones.

An apparatus and method have been proposed that enable multiple musicians at disparate locations to perform together in real-time by transferring to the behavior of their musical instruments the latency of a communications channel. Similarly, a telephone interface comprising balancing circuitry and broadcast means has been proposed so as to allow separately located musicians to perform together via a telephone interconnection, the telephone interface permitting each musician to simultaneously hear a balanced performance by each of the others.

Although such devices and techniques permit the capture of multiple musical inputs, they do not address how to capitalize on the capabilities of more recent, more advanced communication devices described above, namely, the capability to store and convey data content. Accordingly, there appears to be lacking an effective and efficient device or technique for performing data content that comprises, for example, music such that the music can be rendered orchestrally using separate communications devices. Similarly, there appears to be lacking an effective and efficient device or technique for coordinating the performance of data content in the form of a cheer at a college gathering, again, using separate communication devices. Capitalizing on the capabilities of modern communication devices, such as mobile phones, so as to achieve such results thus requires an apparatus or technique for synchronizing the communications devices so that each performs a designated portion of the data content at a designated time during an audible rendering of pre-selected data content. Such an apparatus or technique is currently lacking in the field of electronic communications.

### SUMMARY OF THE INVENTION

The present invention provides apparatus and methods for effecting the orchestrated rendering of pre-selected data content using a plurality of communications devices. An apparatus, according to one embodiment of the present invention, can include a signal transmitting circuit for transmitting a performance signal to at least one communications device, the performance signal comprising a synchronization instruction. The apparatus also can include a synchronization module communicatively connected to the transmitting circuit for generating the synchronization instruction. The synchronization instruction, more particularly, can be based upon the pre-selected data content and can cause each of the communications devices to perform a designated portion of the data content at a designated time during a rendering of the pre-selected data content.

Another embodiment of the present invention is a method for causing an orchestrated rendering of pre-selected data content using a plurality of communications devices. The method can include synchronizing the plurality of communications devices to thereby cause each communications device to audibly and/or visually perform a designated portion of the data content at a designated time during a rendering of the pre-selected data content. The method further can include providing to each communications device the designated portion of the data content that each communications device is synchronized to perform.

### BRIEF DESCRIPTION OF THE DRAWINGS

There are shown in the drawings, embodiments which are presently preferred. It is to be understood, however, that the invention is not limited to the precise arrangements and instrumentalities illustrated.

FIG. 1 is a schematic diagram of an exemplary communications network including an apparatus for causing an orchestrated rendering of pre-selected data content, according to one embodiment of the present invention.

FIG. 2 is a more detailed schematic diagram of the components of the apparatus illustrated in FIG. 1.

FIG. 3 is a schematic diagram of an apparatus for causing an orchestrated rendering of pre-selected data content, according to another embodiment of the present invention.

FIG. 4 is a schematic diagram of an apparatus for causing an orchestrated rendering of pre-selected data content, according to yet another embodiment of the present invention.

FIG. 5 is a schematic diagram of an exemplary communications network including an apparatus for causing an orchestrated rendering of pre-selected data content, according to still another embodiment of the present invention.

FIG. 6 is a flowchart illustrative of a method for orchestrally rendering pre-selected data content, according to another embodiment of the present invention.

FIG. 7 is a flowchart illustrative of a method for orchestrally rendering pre-selected data content, according to still another embodiment of the present invention.

FIG. 8 is a flowchart illustrative of a method for orchestrally rendering pre-selected data content, according to yet another embodiment of the present invention.

### DETAILED DESCRIPTION OF THE DRAWINGS

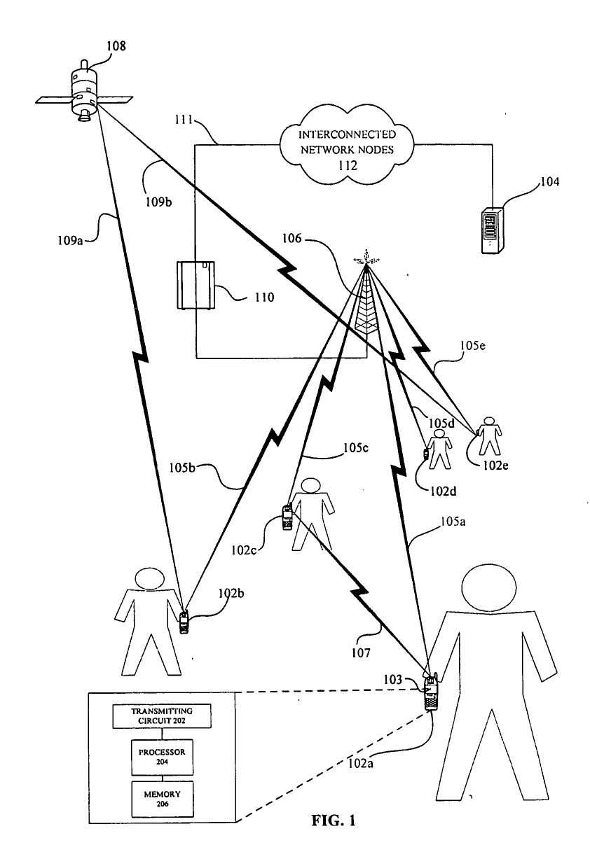

FIG. 1 is a schematic diagram of an exemplary communications network 100 that includes an apparatus 102a that, according to one embodiment of the invention, effects an orchestrated rendering of pre-selected data content using a plurality of communications devices. The apparatus 102a is illustratively a wireless communications device and, more particularly, a wireless mobile phone. The apparatus 102a is illustratively one of a plurality communications devices that comprise the exemplary communications network 100. Other communications devices comprising the exemplary network include additional wireless mobile phones 102b-e and a computing device 104. The computing device 104 is illustratively a specific-purpose device, namely, a server. It will be readily appreciated, however, that the computing device 104 alternatively can be a general purpose computer such as a personal computer (PC) or laptop computer.

As illustrated, the apparatus 102a and other wireless mobile phones 102b-e communicate with one another over wireless cellular network channels 105a-e facilitated by a cellular tower 106. Illustratively, the apparatus 102a and one of the other wireless communications device 102c also communicate with one another via a network-free channel 107. Two of the wireless communications devices 102b, 102e also communicate with one another via a satellite link 109a, 109b facilitated by a communications satellite 108. Note, the apparatus 102a and the other phones 102b-e can include a display 103.

As further illustrated, the cellular tower 106 is communicatively linked via a landline 111 to a router 110, which, in turn, is connected to a plurality of interconnected network nodes 112, such as the Internet or a local area network (LAN). The computing device 104 is communicatively linked to the plurality of interconnected network nodes 112 and, through the router 110 and cellular tower 106, to the other communications devices so that it, too, can communicate with communications devices, such as the apparatus 102a and other wireless mobile phones 102b-e. Alternatively, the computing device 104 can have a wireless communication capability for communicating via a cellular, network-free, and/or satellite-facilitated channel. As will be apparent from the ensuing discussion, the exemplary network 100 and its various components represent only one of many different network configurations in which the apparatus 102a can be used.

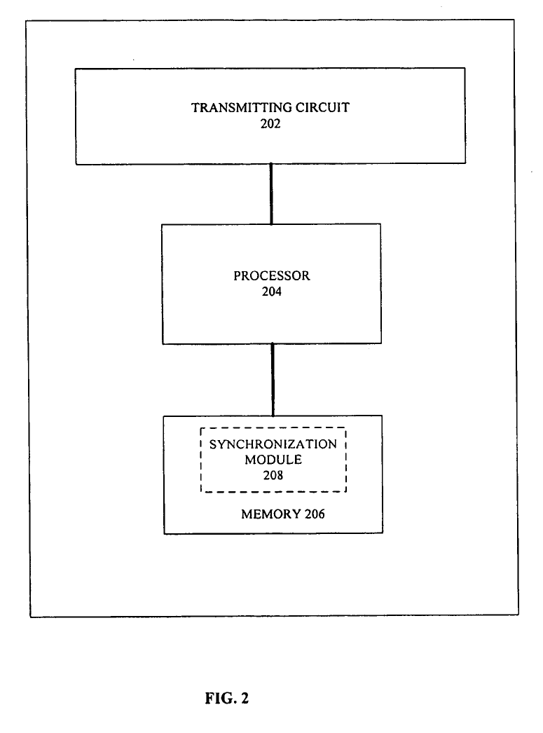

Referring additionally to FIG. 2, the apparatus 102a illustratively includes a transmitting circuit 202 for transmitting a signal to at least one of the other communications devices. The apparatus 102a also illustratively includes a processor 204, such as a microprocessor, connected to the transmitting circuit 202 and a memory 206 connected to the processor 204, the memory for storing machine-readable code that can be processed by the processor.

The apparatus 102a further illustratively includes a synchronization module 208 for generating a synchronization instruction. The synchronization module 208 is illustratively a machine-readable code residing at the memory 206 and configured to be executed by the processor 204 connected thereto. As will be readily understood by one of ordinary skill in the art, the synchronization module 208 alternatively can comprise dedicated hardware circuitry incorporated in or connected to the processor 204. In still another embodiment, the synchronization module 208 can be implemented as wholly separate, hardwired circuit connected to the transmitting circuit 202. And in yet another embodiment, the synchronization module 208 can be implemented as a combination of dedicated hardwired circuitry and machine-readable code. In any of the various embodiments possible, the synchronization module 208 is communicatively connected to the transmitting circuit 202.

Operatively, the synchronization instruction generated by the synchronization module 208 causes other of the communications devices of the exemplary network 100, namely, the wireless mobile phones 102b-e, to perform a designated portion of pre-selected data content at a designated time during an audible (or visual as the case may be) rendering of the pre-selected data content. Illustratively, each of the wireless mobile phones 102b-e comprises a sound generator (not shown). As will be readily understood by one of ordinary skill in the art, the sound generator can comprises for example, sound card or other multimedia expansion board. The sound generator, accordingly, converts digital input into analog signals that drive a speaker (also not shown) contained in the wireless mobile phone, thereby generating music, speech, and/or other sounds based upon the particular pre-selected data content. Likewise, in a visual context, each of the phones 102b-e can include a display driver (not shown) and the display 103 for displaying the pre-selected data content. In a multimedia context, both visual and audible content can be rendered in a synchronized fashion as well.

In one exemplary scenario, the pre-selected data corresponds to a musical score or song stored in the memory 206 of the apparatus as, for example, a MIDI file, WAV file, or other type of electronically storable file. The synchronization module 208 of the apparatus 102a generates one or more synchronization instructions according to which each of the wireless mobile phones 102b-e performs a designated portion of the pre-selected data content at a designated time during an audible and/or visual rendering of the pre-selected data. The one or more synchronization instructions are carried in one or more performance signals transmitted by the transmitting circuit 202 to the wireless mobile phones 102b-e over the wireless cellular network channel 105a. The one or more performance signals is transmitted over one or more of the cellular network channels 105a-e and/or one or more network-free channels 107. The particular portion of the pre-selected data content that a corresponding one of the wireless mobile phones 102b-e is tasked with performing can also be wirelessly conveyed to the corresponding wireless mobile phone in a signal transmitted by the transmitting circuit 202 over a cellular network channel 105a-e and/or network-free channel 107

During a rendering of the pre-selected data content, each of the wireless mobile phoned 102b-e, operating according to the one or more synchronization instructions conveyed to each, performs its portion of the pre-selected data content at a designated time, thereby effecting an orchestral performance of the underlying musical score or song. In one embodiment, for example, each of the wireless mobile phones 102b-e simulates a particular musical instrument when performing the music according to a particular portion of the pre-selected data content. The orchestral rendering of music performed by different communications devices, each simulating different musical instruments results in a musical presentation that, though somewhat artificially produced, more closely approximates that of a true orchestra.

According to a different exemplary scenario, the environment in which the apparatus 102a operates is a large social gathering such as a football game at a sports arena or college stadium. In this setting, the data content corresponds to a cheer or sports team's fight song, and the apparatus 102a operates to synchronize the wireless mobile phones 102b-e of stadium goers rooting for one of the teams. This allows the cheer or team's fight song to be played loudly, in unison over each of the synchronized phones for maximum effect. More particularly, according to one embodiment the apparatus 102a and the wireless mobile phones 102b-e exchange short-range signals over a network-free channel 107 using a near-field wireless protocol, such as Bluetooth. This can reduce the complexity of synchronizing each of the wireless mobile phones 102b-e. Each of the wireless mobile phones, to achieve maximum effect, renders the identical data content—the team fight song—in its entirety, in unison with the other wireless mobile phones. Note, visual effects (such as team logos or teams videos) can also be rendered in a similar fashion.

In an alternate embodiment, each of the wireless mobile phones 102b-e further includes a memory (not shown) for storing at least that portion of the data content that the particular wireless mobile phone is tasked with performing at a designated time. Again, though, the timing of performance and the tasking of each of the wireless mobile phones 102b-e is accomplished in accordance with one or more synchronization instruction generated by the synchronization module 208 stored in the memory 206, processed by the processor 204, and conveyed in a performance signal transmitted by the transmitting circuit 202 of the apparatus 102a.

In still another embodiment, the data content resides on the computing device 104, which as illustrated is a server. Alternatively, though, the computing device 104 can be any other type of computing device, such as a PC or laptop computer, that additionally has a networking capability. As described above, the computing device 104 communicates with the wireless mobile phones 102a-e through the interconnection of network nodes 112 that, in turn, connect via the router 110 to the cellular tower 106, which forms a wireless cellular network with the mobile phones. It will be readily appreciated by one of ordinary skill in the art that the computing device 104, alternatively, can comprise a wireless transmitter or transceiver that facilitates wireless communications, either through the cellular tower, or, between the computing device and the wireless mobile phones 102a-e directly. The apparatus 102a, as already described, can synchronize each of the wireless mobile phones 102a-e to thereby cause an orchestrated rendering of pre-selected data content using the plurality of wireless mobile phones. Instead of conveying all or a portion of the data content along with a signal carrying the synchronization instruction as previously described, however, each of the wireless mobile phones is instructed with the synchronization instruction to retrieve from the computing device 104 the appropriate data content.

In the context of the earlier scenario for rendering data content comprising a musical score or song (or even video or other media presentation), a small group of mobile phone users can, on the basis of one or more synchronization instructions generated by the synchronization module 208, access the data content residing at the computing device 104. The one or more synchronization instructions cause each of the mobile phones 102b-e to perform an orchestrated rendering of the underlying musical score or song (or other media), each mobile phone performing a particular portion of the score or song and/or simulating a particular instrument so as to create a more realistic rendering. According to the other scenario, the group instead can comprise a large group of mobile phone users gathered together a college stadium for a major sporting event. Again, on the basis of the one or more synchronization instructions generated by the synchronization module 208, the mobile phones 102b-e can be synchronized to render a college fight song or team cheer by accessing the data content stored at the computing device 104 and accessible to the mobile phone users.

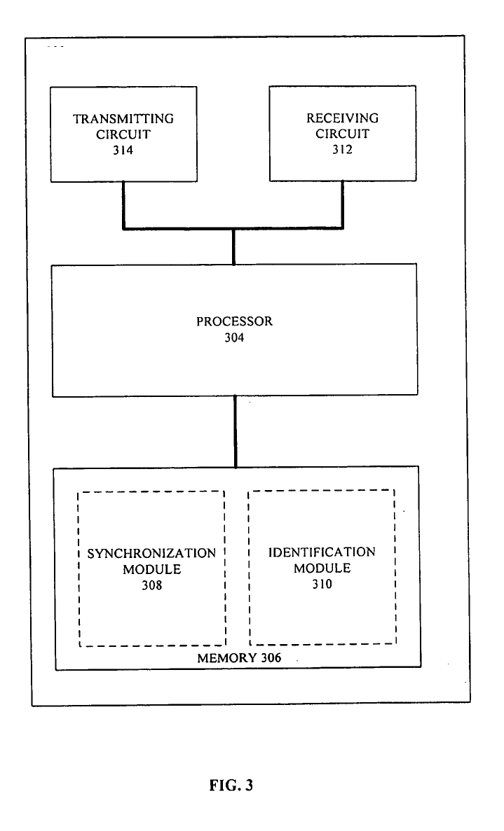

Referring now to FIG. 3, an apparatus 300 for causing an orchestrated rendering of pre-selected data content according to still another embodiment comprises an identification module 310. The identification module 310 identifies one or more communication devices, such as a plurality of wireless mobile phones 102b-e, that can be synchronized for performing a designated portion of the data content at a designated time during an audible rendering of the pre-selected data content. The identification module 310, as illustrated, comprises machine-readable code residing in a memory 306 illustratively contained in the apparatus 300, the machine-readable code being executable with a processor 304 connected to the memory and also illustratively contained in the apparatus. A synchronization module 308 also illustratively resides in the memory, the synchronization module for generating one or more synchronization instructions that causes each of the wireless mobile phones 102b-e to perform audibly and/or visually a designated portion of the pre-selected data content at a designated time during a rendering of the pre-selected data.

Again, as will be readily understood by one of ordinary skill in the art, the identification module 310 alternatively can comprise dedicated hardware circuitry incorporated in or connected to the processor 304. Moreover, according to another embodiment, the identification module 310 can be implemented as wholly separate, hardwired circuit. According to yet another embodiment, the identification module 310 can be implemented as a combination of dedicated hardwired circuitry and machine-readable code.

According to one embodiment, the identification module 310 identifies a communication device on the basis of an identification signal. The identification signal can be transmitted by a communications device for identifying itself to the apparatus 300. The identification signal is illustratively received from the communications device by a receiving circuit 312 contained in the apparatus 300 and connected to the processor 304 therein. In a similar fashion, multiple communications devices can be identified for synchronization by the apparatus 300 according to the mechanisms already described.

According to yet another embodiment, the identification signal is received in response to a wireless query. The wireless query is generated by the identification module 310 and is transmitted by a transmitting circuit 314 also contained in the apparatus 300 and connected to the processor 304 therein. The identification signal transmitted to the apparatus 300 by a communications device identifying itself to the apparatus for synchronization is illustratively transmitted in response to the query.

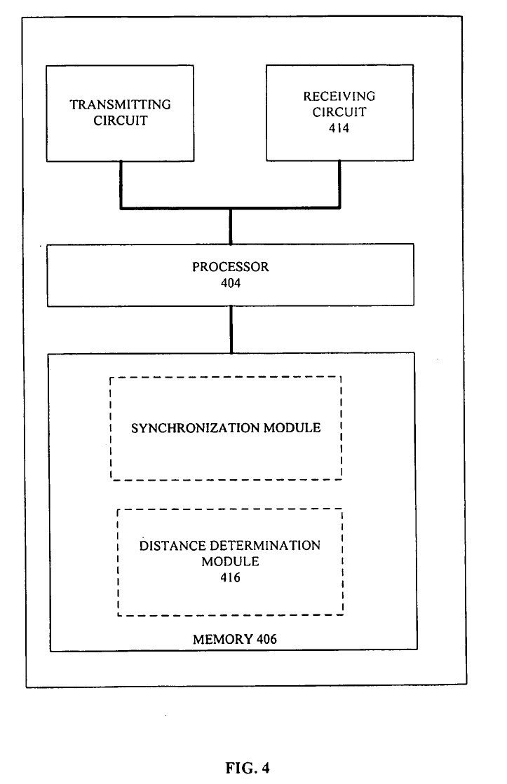

Referring to FIG. 4, an apparatus 400 for causing an orchestrated rendering of pre-selected data content according to yet another embodiment comprises a distance determination module 416. The distance determination module 416 determines a distance between at least two communications devices that can be synchronized for rendering the data content. Since the communications devices are synchronized to render portions of data content at designated times, it can be beneficial, as will be readily appreciated by one ordinary skill in the art, to ascertain distances between the respective communications devices so that the different sound renderings by each of the communication devices reach a desired point where the sound is to be heard at appropriate times. Moreover, by synchronizing communications devices so as to affect the phases of the sound rendering, the joint sound resulting from the synchronized rendering of the data content can be louder or softer depending on the relative phases of each individual sound rendering.

Illustratively, the distance determination module 416 comprises machine-readable code residing in a memory 406 illustratively contained in the apparatus 400 and instantiated by a processor 404 connected to the memory in the apparatus 400. As will be readily understood by one of ordinary skill in the art, the distance determination module 416 alternatively can comprise dedicated hardware circuitry incorporated in or connected to the processor 404. Alternatively, the distance determination module 416 can be implemented as wholly separate, hardwired circuit. According to still another embodiment, the distance determination module 416 can be implemented in a combination of both dedicated hardwired circuitry and machine-readable code.

As further illustrated, the apparatus further includes a receiving circuit 414 for receiving a signal. The receiving circuit 414 receives from each of a plurality of wireless mobile phones or other communications devices a unique location signal indicating the location of the particular communication device. Based upon each of the location signals, the distance determination module 416 determines a distance between at least one the communications devices and at least one other communications device. According to one embodiment, one or more distances are determined by cellular triangulation of location signals conveyed over one or more cellular network channels 105a-e from the respective communication devices. According to still another embodiment, the distance or distances are determined using global positioning satellite (GPS) data, each location signal received by the receiving circuit 414 comprising GPS data corresponding to the location of one or more of the respective communications devices.

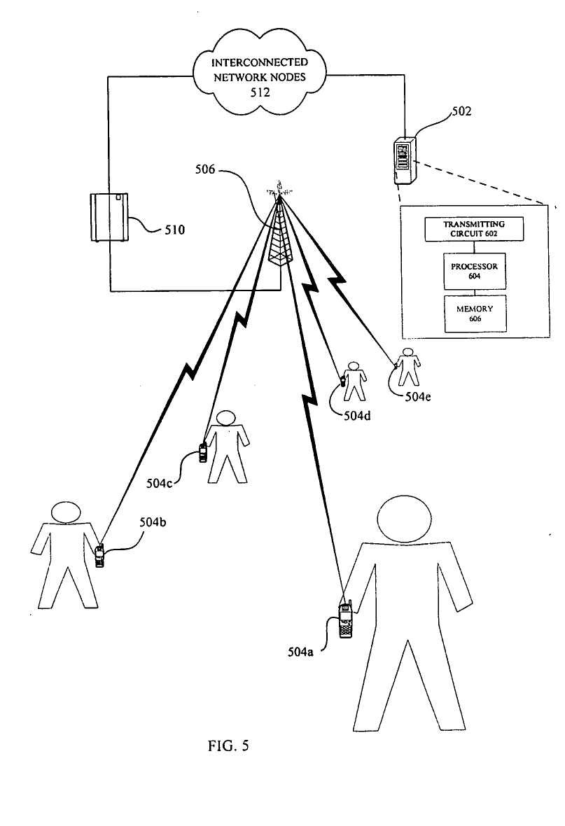

FIG. 5 illustrates another exemplary network 500 that includes an apparatus 502 of effecting an orchestrated rendering of pre-selected data content using a plurality of communications devices, according to yet another embodiment of the present invention. The apparatus 502 is a computing device. As illustrated, the computing device 502 is a special-purpose computer, such as a server, but alternatively, the computing device can be a general-purpose computer, such as a PC, laptop computer, or similar type device. The network 500 further includes a plurality of communications devices, which illustratively are wireless mobile phones 504a-e that together with a cellular tower 506 comprise a cellular network. Alternatively, one or more of the wireless mobile phones 504a-e can be a different type of communications device or even a computing device having a networking capability for communicating with other devices on the basis one or more wireless or landline-based modes.

The apparatus 502 illustratively communicates with each of the plurality of wireless mobile phones 504a-e by communicatively linking to the cellular network. As illustrated, the apparatus links to the cellular network via a connection through an interconnection of network nodes 512, such as the Internet or a LAN, and through a router 510 that as illustrated connects to the cellular tower 506. Alternatively, the apparatus 502 has a wireless transmitting capability for wirelessly communicating through the cellular tower 506 or directly to one or more of the wireless mobile phones 504a-e.

The apparatus, as further illustrated, includes a processor 504, such as a microprocessor, and memory 506 connected to the processor. A synchronization module as described above can comprise machine-readable code residing at the memory 506 for generating one or more synchronization instructions. As also described above, the apparatus can further comprise a transmitting circuit 502 for transmitting performance signals comprising synchronization instructions to a plurality of communications devices such as the plurality of wireless mobile phones 504a-e. Operationally, the synchronization instructions cause each of the communications devices to perform a designated portion of pre-selected data content at a designated time during an audible and/or visual rendering of the pre-selected data content such that music, voice, or other sounds or images are rendered in an orchestral fashion as already described.

FIG. 6 is a flowchart that illustrates a method 600 for causing an orchestrated rendering of pre-selected data content using a plurality of communications devices, according to another embodiment of the present invention. The method 600 illustratively includes, at step 602, synchronizing a plurality of communications devices so that each of the communications devices audibly performs a designated portion of the data content at a designated time during a rendering of the pre-selected data content. According to one embodiment, the synchronization is effected by a communications device that serves as a coordinating communications device, the coordinating communications device transmitting over a cellular network channel or a network-free channel a signal that contains a synchronization instruction for synchronizing the plurality of communications devices. The coordinating communications device can itself perform a designated portion of the data content at a designated time during the rendering of the pre-selected data content. Alternatively, though, the coordinating communications device can simply serve in the role of coordinator without actively participating in the orchestral rendering of the data content.

The method 600 continues at step 604 with each communications device being provided the corresponding designated portion of the data content that each communications device is synchronized to perform according to the synchronization effected at step 602. The method illustratively concludes at step 606.

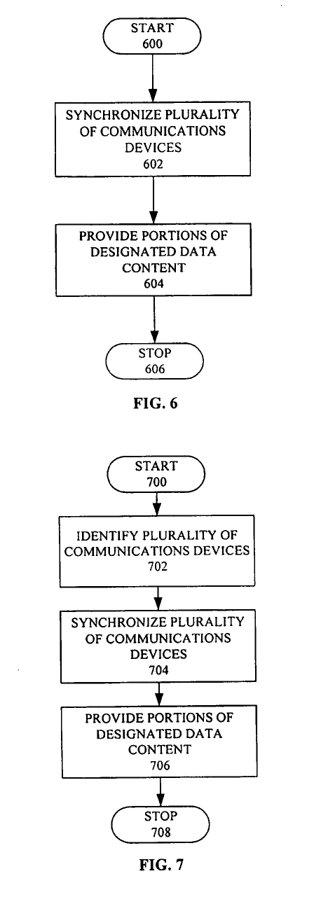

FIG. 7 is a flowchart that illustrates yet another method 700 for causing an orchestrated rendering of pre-selected data content using a plurality of communications devices, according to still another embodiment of the present invention. The method 700 begins at step 702 with the identification of a plurality of communications devices that can by synchronized for rendering the data content. The identification can be made based upon an identification signal, such as a wireless signal. The identification signal is transmitted from each of the plurality of communications devices. The identification signal, moreover, can be transmitted from each of the plurality of communications devices in response to a signal query.

Once the plurality of communications devices have been so identified, the method continues at step 704 with the synchronization of the identified communications devices so that each audibly performs a designated portion of the data content at a designated time during a rendering of the pre-selected data content. The portion of data content that each communication device is to perform is provided to the respective communications devices at step 706. The method concludes at step 708.

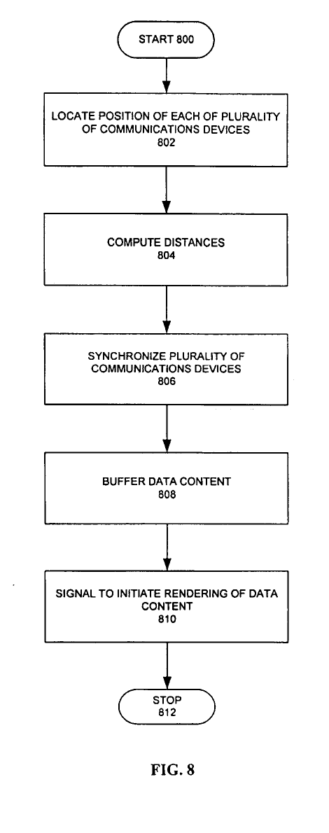

FIG. 8 is a flowchart that illustrates still another method 800 for causing an orchestrated rendering of pre-selected data content using a plurality of communications devices, according to yet another embodiment of the present invention. The method 800 illustratively begins at step 802 with the locating of each of a plurality of communications devices. For example, the location of each communications device can be determined by a cellular triangulation of wireless signals conveyed over cellular network channels. Alternatively, the location of each communications device can be based upon GPS data that is wirelessly transmitted from one of the communications devices to a coordinating device, the GPS data being used to triangulate a distance between at least two communications devices. Accordingly, at least one distance between a pair of communications devices is illustratively determined at step 804 based upon the locations of the respective communications devices.

At step 806, the plurality of communications devices are synchronized to audibly perform a designated portion of the data content at a designated time during a rendering of the pre-selected data content. A coherent rendering of data content typically necessitates compensating for any channel latency associated with the spaced-apart plurality of communications devices. Since the distances between the plurality of communications devices determine, at least in part, the particular time at which respective communications devices are to perform corresponding portions of the data content to achieve a coherent rendering, portions of the data content can be buffered in memories associated with the respective communications devices in advance of the particular communications devices performing the data content. The buffering of at least a portion of the data content in a respective memory illustratively occurs, therefore, at step 808.

When each of the plurality of communications devices has been provided, and, as needed, has buffered, its corresponding portion of the data content, the orchestral rendering of the data content can commence. At step 810, therefore, a signal containing an instruction to begin the rendering of the data content is illustratively transmitted to each of the plurality of communications devices. The method subsequently concludes at step 812.

As already described, aspects of the present invention can be realized in hardware, software, or a combination of hardware and software. Accordingly, these aspects of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system Such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. A method for causing an orchestrated rendering of pre-selected data content using a plurality of communications devices, the method comprising:
synchronizing the plurality of communications devices to thereby cause each communications device to perform a designated portion of the data content at a designated time during a rendering of the pre-selected data content; and
providing to each communications device the designated portion of the data content that each communications device is synchronized to perform.

2. The method of claim 1, further comprising identifying each communications device prior to at least one among an audible rendering or visual rendering of the pre-selected data content.

3. The method of claim 2, wherein identifying comprises transmitting a wireless query to the plurality of communications devices.

4. The method of claim 1, wherein synchronizing comprises buffering at least one designated portion of the data content that at least one of the plurality of communications devices is synchronized to perform.

5. The method of claim 1, further comprising determining a distance between at least two of the communications devices.

6. The method of claim 1, wherein the data content corresponds to music that is performed by the plurality of communications devices during the audible rendering of the pre-selected data content, and wherein each of the plurality of communications devices simulates a pre-selected musical instrument when performing the music.

7. The method of claim 1, wherein the pre-selected data content is performed by the plurality of communications devices in response to a wirelessly transmitted instruction signal instructing the plurality of communications devices to begin the orchestral rendering of the data content.

8. The method of claim 1, further comprising storing the pre-selected data content in a communications device defining a coordinating communications device, the coordinating communications device synchronizing the plurality of communications devices.

9. The method of claim 8, wherein the coordinating communications device communicates with at least one of the plurality of communications devices via a wireless signal transmitted over a network-free channel.

10. The method of claim 8, wherein the coordinating communications device communicates with at least one of the plurality of wireless communications devices via a signal transmitted over a cellular network channel.

11. An apparatus for causing an orchestrated rendering of pre-selected data content, the apparatus comprising:
a signal transmitting circuit for transmitting a performance signal to at least one communications device, the performance signal comprising a synchronization instruction; and
a synchronization module communicatively connected to the transmitting circuit for generating the synchronization instruction;
the synchronization instruction being based upon the pre-selected data content and causing the at least one communications device to perform a designated portion of the data content at a designated time during a rendering of the pre-selected data content.

12. The apparatus of claim 11, further comprising a signal receiving circuit for receiving at least one identification signal, and an identification module communicatively connected to the signal receiving circuit for identifying the at least one communications device in response to the at least one identification signal.

13. The apparatus of claim 12, wherein the identification module is connected to the signal transmitting circuit for causing at least one query signal to be wirelessly transmitted by the transmitting circuit, and wherein the at least one identification signal is received in response to the at least one query signal.

14. The apparatus of claim 11, further comprising a signal receiving circuit for receiving at least one location signal, and a distance determination module connected to the signal receiving circuit for determining a distance between the at least one communications device and at least one other communications device based upon the at least one location signal.

15. The apparatus of claim 14, wherein the determination is based upon at least one of a cellular triangulation of distances and a triangulation of distances using GPS data.

16. The apparatus of claim 11, wherein the at least one other communications device comprises a plurality of other communications devices and the data content corresponds to music that is performed by the plurality of other communications devices during an audible rendering of the pre-selected data content, and wherein the synchronization instruction further causes each of the plurality of other communications devices to simulate a designated musical instrument when performing the music.

17. A computer readable storage medium, the storage medium comprising computer instructions for:
synchronizing a plurality of communications devices to thereby cause a performance of a designated portion of pre-selected data content by a corresponding one of the plurality of communications devices at a designated time during a rendering of the pre-selected data content; and
causing each designated portion of pre-selected data content to be conveyed to a corresponding communications device over an electronic communications channel.

18. The computer readable storage medium of claim 17, further comprising a computer instruction for identifying each one of the plurality of communications devices prior to at least one among an audible rendering or a visual rendering of the pre-selected data content in response to a query conveyed over the electronic communications channel.

19. The computer readable storage medium of claim 17, further comprising a computer instruction for determining a distance between at least two of the plurality of communications devices.

20. The computer readable storage medium of claim 19, wherein the determination is based upon at least one of a cellular triangulation of distances and a triangulation of distances using GPS data.
